(19) United States
(12) Patent Application Publication
(10) Pub. No.: US 2024/0373043 A1
(43) Pub. Date: Nov. 7, 2024

(54) IMAGE CODEC

(71) Applicant: Microsoft Technology Licensing, LLC, Redmond, WA (US)

(72) Inventors: Bin LI, Beijing (CN); Jiahao LI, Beijing (CN); Yan LU, Beijing (CN)

(73) Assignee: Microsoft Technology Licensing, LLC, Redmond, WA (US)

(21) Appl. No.: 18/568,773

(22) PCT Filed: May 11, 2022
(86) PCT No.: PCT/US2022/028653

§ 371 Date: Dec. 8, 2023

(30) Foreign Application Priority Data
Jun. 11, 2021 (CN) 202110655980.9

(51) Int. Cl. H04N 19/192; H04N 19/172

(52) U.S. Cl. CPC H04N 19/192; H04N 19/172

(57) ABSTRACT

According to implementations of the subject matter described herein, a solution is provided for image codec. In the encoding solution, a coded representation of an objective image is obtained, and an objective function associated with a decoder is determined based on the coded representation. Further, a group of adjustments of a group of parameters are determined based on a comparison between a group of change degrees of the objective function with the group of parameters and a threshold degree, and the group of parameters in the coded representation are adjusted based on the group of adjustments so as to obtain an adjusted coded representation. Further, an objective bitstream of the objective image is obtained based on the adjusted coded representation. Thus, more efficient image encoding can be realized.

### BACKGROUND

Image compression is an important and fundamental topic in the field of signal processing and computer vision. With the popular application of high-quality multimedia content, people desire to increase the image compression efficiency and thus reduce transmission bandwidth or storage overheads.

Recently, machine learning-based image compression methods attract increasing interests and have achieved compression performance that is close to that of traditional compression methods. However, unlike traditional codec solutions, it lacks a universal optimization method for machine learning-based image compression to seek efficient codec for different images.

### SUMMARY

According to implementations of the subject matter described herein, there is provided a solution for image codec. In the encoding solution, a coded representation of an objective image is obtained, and an objective function associated with a decoder is determined based on the coded representation. Further, a group of adjustments of a group of parameters are determined based on a comparison between a group of change degrees of the objective function with the group of parameters and a threshold degree, and the group of parameters in the coded representation are adjusted based on the group of adjustments so as to obtain an adjusted coded representation. Further, an objective bitstream of the objective image is obtained based on the adjusted coded representation. Thus, more efficient image encoding can be realized.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a computing environment which can implement a plurality of implementations of the subject matter described herein;

FIG. 2 illustrates a flowchart of the process of image encoding according to some implementations of the subject matter described herein;

FIG. 3 illustrates a schematic view of image encoding according to some implementations of the subject matter described herein;

FIG. 4 illustrates a schematic view of an entropy model according to some implementations of the subject matter described herein;

FIG. 5 illustrates a schematic view of a comparison between performance of an encoding solution according to some implementations of the subject matter described herein and other solutions;

FIG. 6 illustrates a flowchart of the process of image decoding according to some implementations of the subject matter described herein; and

FIG. 7 illustrates a schematic block diagram of an example device that can implement implementations of the subject matter described herein.

Throughout the drawings, the same or similar reference signs refer to the same or similar elements.

### DETAILED DESCRIPTION

The subject matter described herein will now be discussed with reference to several example implementations. It is to be understood these implementations are discussed only for the purpose of enabling persons skilled in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below.

As used herein, the term “neural network” can handle inputs and provide corresponding outputs and it usually includes an input layer, an output layer and one or more hidden layers between the input and output layers. The neural network used in the deep learning applications usually includes a plurality of hidden layers to extend the depth of the network. Individual layers of the neural network model are connected in sequence, such that an output of a preceding layer is provided as an input for a following layer, where the input layer receives the input of the neural network while the output of the output layer acts as the final output of the neural network. Each layer of the neural network includes one or more nodes (also referred to as processing nodes or neurons) and each node processes the input from the preceding layer. In the text, the terms “neural network,” “model,” “network” and “neural network model” may be used interchangeably.

As discussed above, as high-quality multimedia content is widely applied to all aspects of people's life, people desire to increase the image codec efficiency and thus reduce network transmission and storage costs.

With the development of artificial intelligence technology, machine learning-based image codec technology attracts increasing interests. People can realize image coding and decoding by training encoders and decoders. At present, many studies focus on how to design network architectures so as to achieve efficiency image compression. However, encoders resulting from such optimization are usually difficult to perform efficient compression for different images, which will greatly affect the performance and universality of models.

According to implementations of the subject matter described herein, a solution is provided for image codec. In the codec solution, a coded representation of an objective image is obtained, which coded representation may comprise values of a group of parameters corresponding to the objective image. For example, such a coded representation may be obtained by a trained machine learning-based encoder processing the objective image.

Further, an objective function associated with a decoder may be determined based on the coded representation, the decoder being used to decode a bitstream corresponding to the coded representation. For example, such a decoder may be a decoding part in a machine learning-based codec.

The objective function is further used to adjust the coded representation. Specifically, a group of adjustments of the group of parameters may be determined based on a comparison between a group of variation degrees of the objective function with the group of parameters and a threshold degree. Such variation degrees are also referred to as parameter gradients. By comparing different parameter gradients with a threshold gradient, implementations of the subject matter described herein can realize adaptive parameter adjustment.

Further, the group of parameters are adjusted based on the group of adjustments, so as to obtain an adjusted coded representation and further obtain an objective bitstream of the objective image.

Thereby, implementations of the subject matter described herein may utilize the objective function to achieve direct optimization of the coded representation and further achieve adaptive optimization for different images. In addition, by determining an adjustment of each parameter based on the threshold gradient, implementations of the subject matter described herein can further take into consideration the characteristic of quantization operation to be performed to the coded representation, thereby increasing the compression efficiency. The basic principle and several example implementations of the subject matter described herein will be illustrated with reference to the drawings below.

### Example Environment

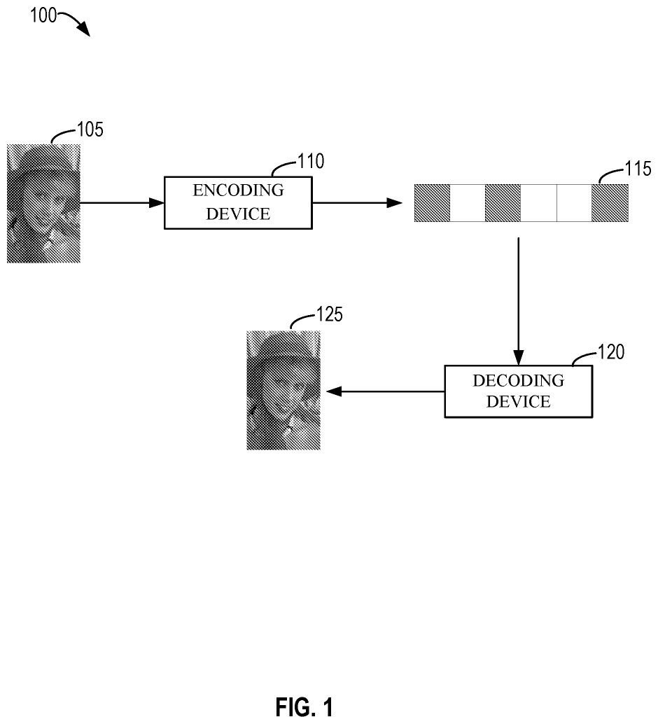

FIG. 1 shows a block diagram of an environment 100 in which a plurality of implementations of the subject matter described herein can be implemented. It should be understood that the environment 100 shown in FIG. 1 is merely exemplary and should not constitute any limitation on the functionality and scope of implementations of the subject matter described herein.

As shown in FIG. 1, an encoder 110 can obtain an objective image 105 and convert the same into a corresponding bitstream 115. In some implementations, the objective image 105 may comprise or be an image which is captured by any type of image capture device for capturing a real world image. Or the objective image 105 may be an image which is generated by any type of image generating device.

It should be understood that in the image coding field, the terms “picture,” “frame” and “image” may be used as synonyms. Image coding (or usually referred to as coding) comprises two parts, i.e., image encoding and image decoding. Image encoding is performed on the source side, usually comprising processing (e.g., compressing) a raw video image so as to reduce the data amount for representing the video image (more efficient storage and/or transmission). Image decoding is performed on the destination side, usually comprising reverse processing relative to an encoder so as to rebuild an image. The encoding and decoding parts are collectively referred to as codec.

As shown in FIG. 1, a decoding device 120 may receive the bitstream 115 and obtain a decoded image 125 by decoding. In some implementations, the encoding device 110 and the decoding device 120 may be different devices, and the bitstream 115 may be sent from the encoding device 110 to the decoding device 120 through communication transmission, for example. Such a bitstream 115 may be encapsulated into a suitable format such as a message, and/or uses any type of transmission coding or processing so as to be transmitted over a communication link or communication network.

Although FIG. 1 shows the encoding device 110 and the decoding device 120 as independent devices, device embodiments may also simultaneously comprise the encoding device 110 and the decoding device 120 or corresponding functions. In these embodiments, the encoding device 110 or corresponding function and the decoding device 120 or corresponding function may be implemented by the same hardware and/or software or different hardware and/or software or any combination thereof.

Processes of image encoding and image decoding will be described in detail below.

### Encoding Process

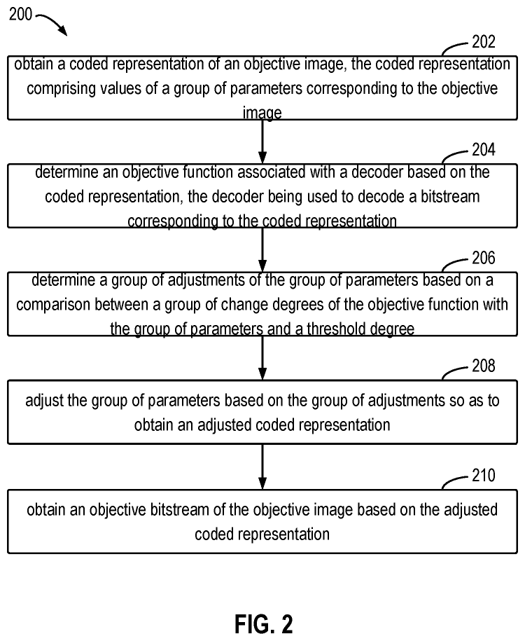

FIG. 2 shows a flowchart of an image encoding process 200 according to some implementations of the subject matter described herein. The process 200 may be implemented by the encoding device 110 in FIG. 1, for example.

As shown in FIG. 2, at 202, the encoding device 110 obtains a coded representation of the objective image 105, the coded representation comprising values of a group of parameters corresponding to the objective image 105.

In some implementations, the coded representation may be an initial coded representation obtained by suitable encoding technology. For example, the coded representation may be a latent representation obtained by using any suitably trained machine learning-based encoder. As another example, the coded representation may also be generated in other way, for example, such a coded representation may further be a group of random representations.

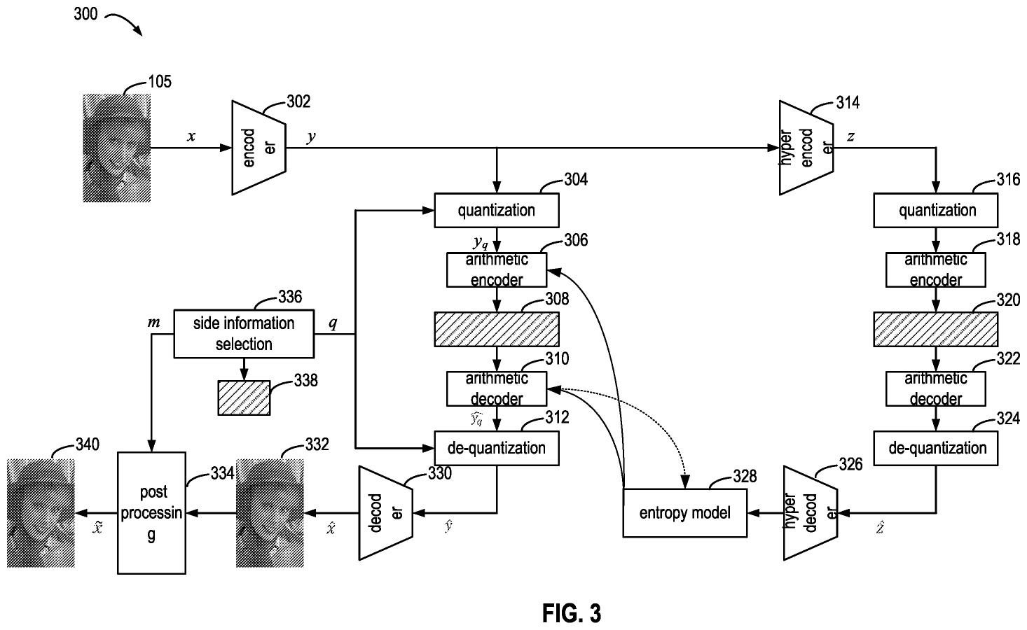

FIG. 3 shows a schematic view 300 of image encoding according to some implementations of the subject matter described herein. As depicted, the objective image 105 (denoted as x) may be provided to a machine learning-based encoder 302, which may convert the objective image 105 into a first coded representation y.

As an example, the first coded representation y may be denoted as:

$$y = {g}_{a} ( x \vert {ϕ}_{g} ) \qquad ( 1 )$$

Where gₐ(⋅) denotes an analysis transform of the encoder 302, and ϕ_{g} denotes a parameter of the encoder 302.

In some implementations, the first coded representation y may comprise data corresponding to different areas in the objective image 105. For example, the objective image 105 may be input to the encoder 302 to obtain values of a corresponding group of parameters. For example, the objective image 105 may be a 1024*768 pixel size, the encoder 302 may generate values of 64*48*128 parameters based on the objective image 105, wherein 128 represents dimensions of data. In this way, each group of 128-dimensional data may correspond to an image block of a 16*16 pixel size in the objective image 105. It should be understood that the above numbers of parameters merely serve as an example and are not intended to limit the subject matter described herein.

As shown in FIG. 3, in some implementations, the first coded representation y may further be provided to a hyper encoder 314, and then a second coded representation z may be obtained. The second coded representation z can be used to indicate distribution characteristics of the first coded representation y. Such distribution characteristics may be used to indicate the spatial dependency between different elements of the first coded representation y.

As an example, the second coded representation z may be denoted as:

$$𝓏 = {h}_{a} ( y \vert {ϕ}_{h} ) \qquad ( 2 )$$

Where hₐ(⋅) denotes a transform of the hyper encoder 314, and ϕₕ denotes a parameter of the hyper encoder 314.

For the specific implementation of the hyper encoder 314 and a hyper decoder 326 to be described below, reference may be made to the article “Variational Image Compression with a Scale Hyperprior” (Johannes Balle, D. Minnen, S. Singh, S. J. Hwang, N. Johnston, “Variational Image Compression with a Scale Hyperprior”, Intl. Conf. on Learning Representations (ICLR), pp. 1-23, 2018), and details are not provided here.

At 204, the encoding device 110 determines an objective function associated with a decoder based on the coded representation, the decoder being used to decode a bitstream corresponding to the coded representation. In some implementations, the decoder may correspond to the above discussed machine learning-based encoder so as to realize the decoding process corresponding to the encoder.

Take FIG. 3 as an example. In the encoding process, the first coded representation y is provided to a quantization unit 304 to perform quantization and obtain a quantization result y_{q}, and is encoded as a bitstream 308 through an arithmetic encoder 306. Accordingly, in the decoding process, the bitstream 308 may be decoded as [symbol] through an arithmetic decoder 310 and transformed into ŷ through a de-quantization unit 312. A decoder 330 may obtain a decoded image 332 (denoted as \hat{x}) based on a de-quantization result ŷ, thereby realizing decoding.

In some implementations, when the coded representation further comprises the second coded representation z, in the encoding process, similarly the second coded representation z may be transformed into a bitstream 320 through a quantization unit 316 and an arithmetic encoder 318. Accordingly, in the decoding process, the bitstream 320 may obtain a de-quantization result \hat{z} through an arithmetic decoder 322 and a de-quantization process 324 and then be input into an entropy model 328 after being processed by a hyper decoder 326, so as to be used for determining entropy parameters for the arithmetic encoder 306 and the arithmetic decoder 310. In some examples, such entropy parameters may comprise a parameter for indicating a mean value and a parameter for indicating a variance.

In some implementations, the objective function (also referred to as a loss function) associated with the decoder may be determined based on at least one of: an expected size of a bitstream generated based on the coded representation, and a difference between a decoded image generated based on the bitstream and the objective image. Specifically, in the example of FIG. 3, the objective function associated with the decoder may be determined as:

$$\begin{matrix}ℒ = ℛ ( {{y}_{q}}^{} ) + ℛ ( \hat{z} ) + λ \cdot 𝒟 ( x , \hat{x} ) \\ = 𝔼 [ - {log}_{2} ( {P}_{{\check{y}}_{q} \vert \check{𝓏}} ( {\check{y}}_{q} \vert \check{𝓏} ) ) ] + 𝔼 [ - {log}_{2} ( {p}_{{𝓏}^{} \vert {ϕ}_{𝓏}} ( {𝓏}^{} \vert {ϕ}_{𝓏} ) ) ] + λ \cdot 𝒟 ( x , \check{x} ) ,\end{matrix} \qquad ( 3 )$$

Where [symbol] ( [symbol] ) is used to indicate an encoding rate corresponding to the first coded representation y, i.e., associated with the size of the bitstream 308; [symbol] (\hat{z}) is used to indicate an encoding rate of the second coded representation z, i.e., associated with the size of the bitstream 320; [symbol] (x, \hat{x}) denotes the difference between the objective image 305 and the decoded image 332 generated through the bitstream 308 and the bitstream 320, [symbol] [−log₂( [symbol] _{|\hat{z}}( [symbol] |\hat{z}))] and [symbol] [−log₂(P_{\hat{z}|ϕ}_{_{z}}(\hat{z}|ϕ_{z}))] denote estimations of bit numbers needed by the encoding y and z respectively; λ denotes a weight coefficient.

It should be understood that the objective function (3) is intended to enhance the encoding compression ratio where the image distortion is reduced. In addition, a balance may be stricken between reducing the image distortion and enhancing the encoding compression ratio by adjusting the value of λ.

Still with reference to FIG. 2, at 206, the encoding device 110 determines a group of adjustments of the group of parameters based on a comparison between a group of variation degrees of the objective function with the group of parameters and a threshold degree.

In some implementations, the encoding device 110 may calculate a gradient value of the objective function related to each parameter in the group of parameters by gradient back propagation, i.e., the variation degree of the objective function with each parameter.

In the forward pass, the quantization performed by the quantization unit 304 is implemented through rounding shown in Formula (4):

$${y}_{q} = Q ( y ) = [ y - μ ] , \qquad ( 4 )$$

Where denotes a rounding operation. To implement gradient back propagation, in the gradient backward pass, Formula (4) is replaced by an identity for calculating a gradient, which is as shown by Formula (5):

$$\frac{d}{dy} Q ( y ) = \frac{d}{dy} [ y - μ ] := \frac{d}{dy} ( y - μ ) \qquad ( 5 )$$

Take the first coded representation y as an example. Based on gradient back propagation, the gradient of the objective function related to each parameter in the first coded representation y may be obtained.

Since the quantization process uses rounding as described in Formula (4), on the one hand, the encoding result might not be affected if a certain parameter is adjusted using a small step size. For example, if the value of a certain parameter is adjusted from 1.11 to 1.12, then the value always equals 1 after being rounded, so an adjustment of 0.01 will not cause any change.

On the other hand, some slight adjustments also might cause great impact on the encoding result. For example, if the value of a certain parameter is adjusted from 1.11 to 1.12, then it will be quantized to 1 before adjustment and quantized to 2 after adjustment. This will result in a possible decrease in the encoding efficiency.

To prevent a uniform step size from causing the above problems, in some implementations, the encoding device 110 may further compare the gradient of each parameter with a threshold gradient and determine an adjustment of each parameter during the iteration only based on a comparison result.

In some implementations, if the gradient of the first parameter in the group of parameters is less than or equal to the threshold gradient, i.e., the first variation degree of the objective function with the first parameter is less than the threshold degree, then the encoding device 110 may determine the adjustment of the first parameter as zero in the current iteration.

In this way, for a parameter with a smaller gradient, the encoding device 110 may not adjust the value of the parameter in the iteration, so as to avoid a decrease of encoding efficiency caused by slight adjustment.

In some implementations, if the gradient of a second parameter in the group of parameters is larger than the threshold gradient, i.e., the second variation degree of the objective function with the second parameter is larger than or equal to the threshold degree, then the encoding device 110 may determine an adjustment for the second parameter based on the second variation degree, so as to cause the adjustment to be directly proportional to the second variation degree.

In this way, for a parameter with a larger gradient, the encoding device 110 may adaptively determine the step size of the parameter adjustment according to the size of a gradient in iteration, thereby accelerating the process of iteration convergence.

In some implementations, the encoding device 110 may determine the largest variation degree in the group of variation degrees and determine an adjustment based on a ratio of the second variation degree to the largest variation degree, so as to cause the adjustment to be directly proportional to the ratio of the second variation degree to the largest variation degree.

As an example, the encoding device 110 may determine the maximum gradient among gradients of the group of parameters and set an adjustment of a parameter corresponding to the maximum gradient in each iteration as a predetermined step size. Subsequently, the encoding device 110 may determine a product of a ratio of the gradient of other parameter to the maximum gradient and the predetermined step size and determine a result of the product as a step size by which other parameter is to be adjusted.

In some implementations, the threshold gradient for comparison may be determined based on a product of the maximum gradient in the group of gradients associated with the group of parameters and a predetermined coefficient. Alternatively, the threshold gradient may also be a predetermined gradient.

It should be understood that the above discussed size of variation degree is intended to indicate the size of an absolute value of variation degree, i.e., the size of an absolute value of gradient, without its sign being considered.

Take the first coded representation y as an example. It may be formulated as Formula (6) in iteration:

$${y}_{t + 1} = \{ \begin{matrix}{y}_{t} - α \cdot \frac{{y}_{t}^{′}}{\vert {y}_{t}^{′} {\vert}_{max}} , & \vert {y}_{t}^{′} \vert > β \cdot \vert {y}_{t}^{′} {\vert}_{max} \\ {y}_{t} , & otherwise\end{matrix} \qquad ( 6 )$$

Where [symbol] denotes the gradient of [symbol] , t denotes the iteration index, α denotes the predetermined adjustment step, β denotes the predetermined coefficient for determining threshold gradient, | [symbol] |ₘₐₓ denotes the maximum value among absolute values of the gradient of [symbol] .

Based on Formula (6), regarding a parameter for which the ratio of the absolute value of the gradient to the absolute value of the maximum gradient is larger than β, its adjustment step is the product of the ratio and the predetermined step α; regarding a parameter for which the ratio of the absolute value of the gradient to the absolute value of the maximum gradient is less than or equal to β, it is not adjusted in the current iteration, i.e., the adjustment equals zero.

At 208, the encoding device 110 adjusts the group of parameters based on the group of adjustments to obtain the adjusted coded representation. Take FIG. 3 as an example. The encoding device 110 adjusts the first coded representation y according to the above discussed Formula (6), so as to obtain the adjusted first coded representation.

In some implementations, regarding the second coded representation z, the encoding device 110 may use the hyper encoder to process the adjusted first coded representation to re-generate a new second coded representation.

In some further implementations, the second coded representation z may further be jointly optimized with the first coded representation y. That is, the encoding device 110 may take the first coded representation y and the second coded representation z as to-be-optimized parameters and jointly optimize them based on the objective function (3).

During joint optimization, the encoding device 110 may determine the step by which the parameter in the second coded representation z is adjusted in each iteration, according to the process discussed with reference to step 206, rather than using the hyper encoder to re-generate a new second coded representation.

In other implementations, considering that the bitstream 320 corresponding to the second coded representation z has less bits, the second coded representation z may also not be adjusted.

In some implementations, the encoding device 110 may iteratively adjust the first coded representation y and/or the second coded representation z according to the above discussed process, until the convergence condition is met. Such a convergence condition may be that the change value of the objective function is less than the predetermined threshold after a predetermined number of iterations.

Still with reference to FIG. 2, at block 210, the encoding device 110 obtains an objective bitstream of the objective image based on the adjusted coded representation.

In some implementations, after completion of the optimization of the coded representation, the encoding device 110 may obtain the objective bitstream of the objective image by using the quantization unit and the arithmetic encoder.

Take FIG. 3 as an example. The encoding device 110 may use the quantization unit 304 and the arithmetic encoder 306 to transform the adjusted first coded representation y into a bitstream; in addition, the encoding device 110 may further use the quantization unit 316 and the arithmetic encoder 318 to transform the adjusted second coded representation z into a bitstream.

As discussed above, the entropy model 328 needs to determine an entropy encoding parameter related to the mean value μ and an entropy encoding parameter related to the variance σ, so as to be used for guiding the encoding process of the arithmetic encoder 306 and the decoding process of the arithmetic decoder 310.

In some traditional solutions, the entropy model 328 needs to use contextual parameters to determine the mean value and the variance, which will compound the model complexity and damage the parallelism on the encoding side.

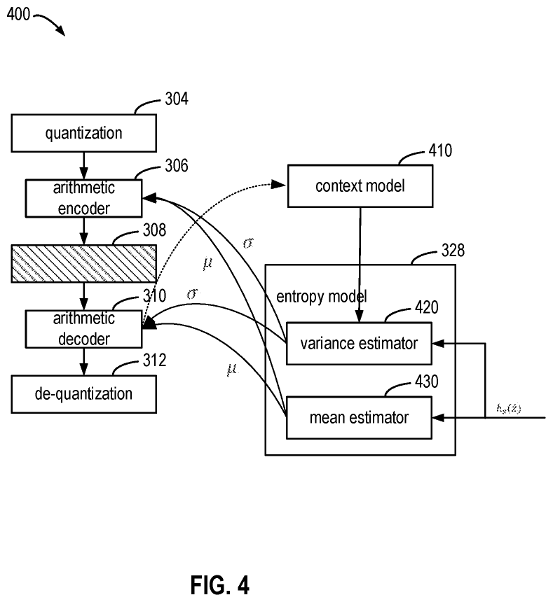

FIG. 4 shows a schematic view 400 of an entropy model according to some implementations of the subject matter described herein. As depicted, the entropy model 328 comprises a variance estimator 420 and a mean estimator 430. Unlike traditional entropy models, the mean estimator 430 does not rely on an output result of a context model 410 when determining the mean value u.

Specifically, the calculation process of the entropy model shown in FIG. 4 may be denoted as:

$$\begin{matrix}𝓏 = {h}_{a} ( y \vert {ϕ}_{h} ) \\ {ψ}_{h} = {h}_{s} ( \hat{𝓏} \vert {θ}_{h} ) \\ {ψ}_{c} = f ( {\hat{y}}_{{i}_{1}} , {\hat{y}}_{{i}_{2}} , … , {\hat{y}}_{{i}_{n}} \vert {θ}_{f} ) \\ μ = {e}_{μ} ( {ψ}_{h} \vert {θ}_{{e}_{μ}} ) \\ σ = {e}_{σ} ( {ψ}_{h} , {ψ}_{e} \vert {θ}_{{e}_{σ}} ) .\end{matrix} \qquad ( 7 )$$

Where hₐ(⋅) and hₛ(⋅) denote the treatment process of the hyper encoder 314 and the hyper encoder 326, respectively, ϕₕ and θₕ, denote the model parameter of the hyper encoder 314 and the hyper encoder 326 respectively; f(⋅) denotes the treatment process of the context model 410, iₗ to iₙ denote indexes of a group of associated locations associated with a given location that currently needs to generate a bitstream; e_{μ}(⋅) and e_{σ}(⋅) denote the treatment process of the mean estimator 430 and the variance estimator 320, θₑ_{_{μ}} and θₑ_{_{σ}} denote the model parameter of the mean estimator 430 and the variance estimator 320 respectively. It should be understood that the group of associated locations denoted by iₗ to iₙ refer to other locations before the current location based on a decoding order.

As seen from Formula μ=e_{μ}(ψₕ|θₑ_{_{μ}}), the mean estimator 430 no longer relies on a result of the context model 410 while calculating a mean value. In this way, implementations of the subject matter described herein provide support for the parallelism of encoding processes at different locations.

In some implementations, to optimize the codec process, side information may further be encoded in the objective bitstream. As shown in FIG. 3, a side information selecting unit 336 may be used to determine side information in a to-be-encoded bitstream 338.

In some implementations, the side information may comprise first side information to indicate a quantization parameter for quantizing the coded representation. As shown in FIG. 3, the side information selecting unit may determine a quantization step q and provide the same to the quantization unit 304 and the de-quantization unit 312 so as to perform quantization and de-quantization accordingly.

Usually, in machine learning-based codec models, the quantization step is always fixed as 1, which will affect the compression ratio. By including the quantization step q in the bitstream, the quantization step performed by the quantization unit 304 may be denoted as:

$${y}_{q} = Q ( y ) = [ \frac{y - μ}{q} ] , \qquad ( 8 )$$

In this way, the compression ratio may be further increased.

Accordingly, during gradient back propagation, the corresponding gradient calculation process (5) may be updated as:

$$\frac{d}{dy} Q ( y ) = \frac{d}{dy} [ \frac{y - μ}{q} ] := \frac{d}{dy} ( \frac{y - μ}{q} ) \qquad ( 9 )$$

In some implementations, the encoding device 110 may determine an optimum quantization step that is suitable for the objective image 105 by searching a candidate set of the quantization step q. Alternatively, the quantization step may be manually configured as a configuration parameter of the encoder.

In some implementations, the side information may further comprise second side information to indicate a post processing parameter m that indicates post processing is to be performed to the decoded image generated from the objective bitstream. As shown in FIG. 3, the side information selecting unit may further determine the post processing parameter m and provide the same to a post processing unit 334 for performing corresponding post processing. The processing of the post processing unit 334 may be denoted as:

$$\tilde{x} = ℱ ( \hat{x} , m ) \qquad ( 10 )$$

Wherein [symbol] (⋅) denotes the process performed by the post processing unit 334.

Like the determining process for the quantization step q, the encoding device 110 may determine the post processing parameter m that is suitable for the objective image 105 by the candidate set of the post processing parameter. Alternatively, considering that encoding and decoding operations can be simultaneously performed on the encoding side in the machine learning-based codec solution, the encoding device 110 may also calculate the post processing parameter m according to a difference between the input image 105 and the decoded image 332.

As an example, the post processing parameter m may indicate the noise level of the decoded image 332, and the post processing performed by the post processing unit 334 may be a denoising process. When the noise level is high, the post processing unit 334 may, for example, perform a denoising process with higher intensity; on the contrary, when the noise level is lower, the post processing unit 334 may perform a denoising process with lower intensity. It should be understood that other appropriate post processing parameters may also be encoded as side information.

In this way, implementations of the subject matter described herein can further encode the side information in the bitstream, thereby helping to perform corresponding optimization on the decoding side, enhance the codec efficiency and optimize the quality of the decoded image.

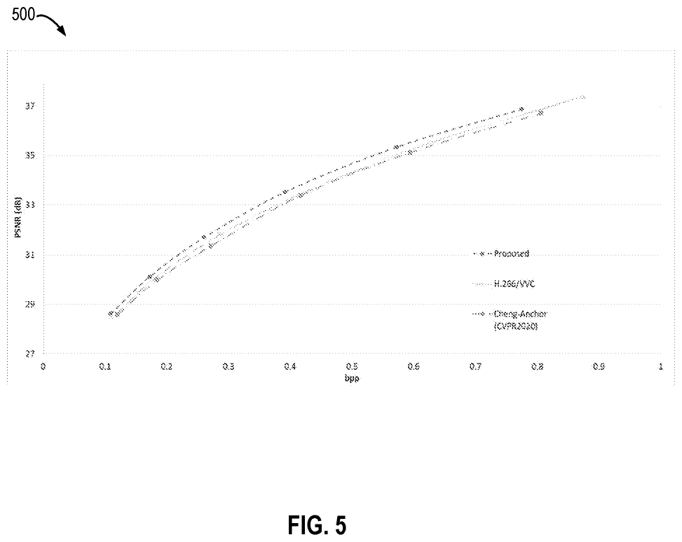

FIG. 5 further shows a schematic view 500 of a comparison between performance of the encoding solution according to some implementations of the subject matter described herein and other solutions. As shown in FIG. 5, the horizontal axis of the schematic view 500 denotes bpp (bits per pixel), and the vertical axis is PSNR (Peak Signal to Noise Ratio). As seen from FIG. 5, the solution of the subject matter described herein obviously outperforms the VVC solution and the solution proposed in the article “Learned image compression with discretized Gaussian mixture likelihoods and attention modules” in terms of the compression ratio.

### Decoding Process

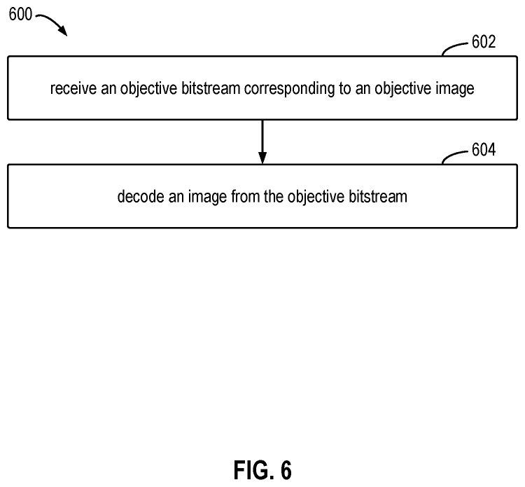

FIG. 6 shows a flowchart of an image decoding process 600 according to some implementations of the subject matter described herein. The process 600 may be implemented by the decoding device 120 in FIG. 1, for example.

As shown in FIG. 6, at block 602, the decoding device 120 receives an objective bitstream corresponding to an objective image. The specific generating process for the objective bitstream has been described in detail and thus is not detailed here. At block 604, the decoding device 120 decodes an image from the objective bitstream.

In some implementations, the decoding device 120 further decodes side information from the objective bitstream. In some implementations, the side information comprises the above discussed first side information to indicate a quantization parameter for quantizing a coded representation.

In some implementations, after the quantization parameter is decoded from the objective bitstream, the decoding device 120 may send the quantization parameter to a de-quantization unit to perform corresponding de-quantization operation.

In some implementations, the side information comprises the above discussed second side information to indicate a post processing parameter for performing post processing to the decoded image generated from the objective bitstream.

In some implementations, after the post processing parameter is decoded from the objective bitstream, the decoding device 120 may send the post processing parameter to a post processing unit to perform post processing operation to the image that results from the decoding.

### Example Device

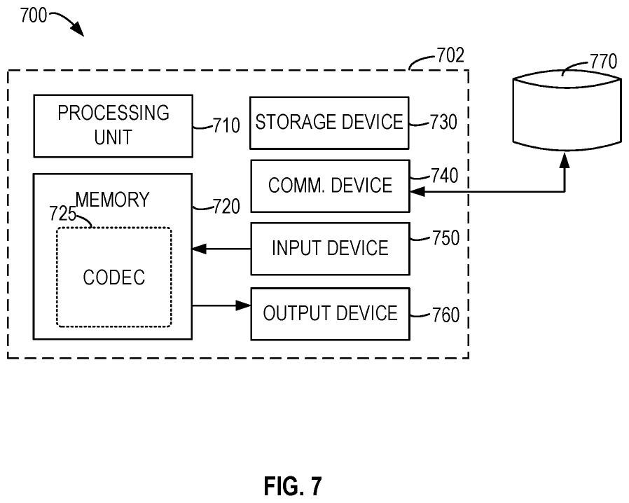

FIG. 7 illustrates a schematic block diagram of an example device 700 that can implement implementations of the subject matter described herein. The device 700 may be used to implement the encoding device 110 and/or decoding device 120 in FIG. 1. It should be understood that the device 700 shown in FIG. 7 is only exemplary and shall not constitute any limitation on the functions and scopes of the implementations described by the subject matter described herein. As shown in FIG. 7, components of the device 700 may include, but is not limited to, one or more processors or processing units 710, a memory 720, a storage device 730, one or more communication units 740, one or more input devices 750, and one or more output devices 760.

In some implementations, the device 700 may be implemented as various user terminals or service terminals. The service terminals may be servers, large-scale computing devices, and the like provided by a variety of service providers. The user terminal, for example, is a mobile terminal, a fixed terminal or a portable terminal of any type, including a mobile phone, a site, a unit, a device, a multimedia computer, a multimedia tablet, Internet nodes, a communicator, a desktop computer, a laptop computer, a notebook computer, a netbook computer, a tablet computer, a Personal Communication System (PCS) device, a personal navigation device, a Personal Digital Assistant (PDA), an audio/video player, a digital camera/video, a positioning device, a television receiver, a radio broadcast receiver, an electronic book device, a gaming device or any other combination thereof consisting of accessories and peripherals of these devices or any other combination thereof. It may also be predicted that the device 700 can support any type of user-specific interface (such as a “wearable” circuit, and the like).

The processing unit 710 may be a physical or virtual processor and may execute various processing based on the programs stored in the memory 720. In a multi-processor system, a plurality of processing units executes computer-executable instructions in parallel to enhance parallel processing capability of the device 700. The processing unit 710 can also be known as a central processing unit (CPU), microprocessor, controller and microcontroller.

The device 700 usually includes a plurality of computer storage mediums. Such mediums may be any attainable medium accessible by the device 700, including but not limited to, a volatile and non-volatile medium, a removable and non-removable medium. The memory 120 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The memory 720 may include one or more encoding/decoding modules 725, which program modules are configured to perform various encoding functions/decoding functions described herein. An encoding/decoding module 725 module may be accessed and operated by the processing unit 710 to realize corresponding functions. The storage device 730 may be a removable or non-removable medium, and may include a machine-readable medium (e.g., a memory, a flash drive, a magnetic disk) or any other medium, which may be used for storing information and/or data and be accessed within the device 700.

Functions of components of the device 700 may be realized by a single computing cluster or a plurality of computing machines, and these computing machines may communicate through communication connections. Therefore, the device 700 may operate in a networked environment using a logic connection to one or more other servers, a Personal Computer (PC) or a further general network node. The device 700 may also communicate through the communication unit 740 with one or more external devices (not shown) as required, where the external device, e.g., a database 770, a storage device, a server, a display device, and so on, communicates with one or more devices that enable users to interact with the device 700, or with any device (such as a network card, a modem, and the like) that enable the device 700 to communicate with one or more other computing devices. Such communication may be executed via an Input/Output (I/O) interface (not shown).

The input device 750 may be one or more various input devices, such as a mouse, a keyboard, a trackball, a voice-input device, and the like. The output device 760 may be one or more output devices, e.g., a display, a loudspeaker, a printer, and so on.

### Example Implementations

Some example implementations of the subject matter described herein are listed below.

In a first aspect, the subject matter described herein provides a method for image encoding. The method comprises: obtaining a coded representation of an objective image, the coded representation comprising values of a group of parameters corresponding to the objective image; determining an objective function associated with a decoder based on the coded representation, the decoder being used to decode a bitstream corresponding to the coded representation; determining a group of adjustments of the group of parameters based on a comparison between a group of change degrees of the objective function with the group of parameters and a threshold degree; adjusting the group of parameters based on the group of adjustments so as to obtain an adjusted coded representation; and obtaining an objective bitstream of the objective image based on the adjusted coded representation.

In some implementations, determining the adjustment of the parameter comprises: in response to determining that a first change degree of the objective function with a first parameter is less than or equal to the threshold degree, determining an adjustment of the first parameter to zero.

In some implementations, determining the adjustment of the parameter comprises: in response to determining that a second change degree of the objective function with a second parameter is larger than the threshold degree, determining an adjustment of the second parameter based on the second change degree so as to cause the adjustment to be proportional to the second change degree.

In some implementations, determining the adjustment based on the second change degree comprises: determining a maximum change degree in the group of change degrees; and determining the adjustment based on a ratio of the second change degree to the maximum change degree so as to cause the adjustment to be proportional to the ratio.

In some implementations, the threshold degree is determined based on a product of a maximum change degree in the group of change degrees and a predetermined coefficient.

In some implementations, the coded representation comprises a first coded representation, the first coded representation being generated by using an encoder to process the objective image.

In some implementations, the coded representation further comprises a second coded representation, the second coded representation being generated based on the first coded representation so as to indicate a distribution characteristic of the first coded representation.

In some implementations, the coded representation comprises multiple partial coded representations corresponding to multiple locations in the objective image, and generating the bitstream comprises: with respect to a given location among the multiple locations, determining a first entropy encoding parameter for indicating a mean value based on the second coded representation, the first entropy encoding parameter being irrelevant to a contextual parameter, the contextual parameter being used to indicate a coded representation of a group of associated locations associated with a given location among the multiple locations; and generating a partial bitstream corresponding to the given location in the objective bitstream at least based on the first entropy encoding parameter.

In some implementations, generating the partial bitstream corresponding to the given location in the objective bitstream at least based on the first entropy encoding parameter comprises: determining a second entropy encoding parameter for indicating a variance based on the second coded representation and the contextual parameter; and generating the partial bitstream corresponding to the given location in the objective bitstream based on the first entropy encoding parameter and the second entropy encoding parameter.

In some implementations, the objective bitstream is encoded with at least one of: first side information, which indicates a quantization parameter for quantizing the coded representation, or second side information, which indicates a post-processing parameter for performing post-processing to a decoded image generated from the objective bitstream.

In some implementations, adjusting the group of parameters based on the group of adjustments comprises: iteratively adjusting the coded representation until a convergence condition associated with the objective function is met.

In a second aspect, the subject matter described herein provides a method for image decoding. The method comprises: receiving an objective bitstream corresponding to an objective image; and decoding an image from the objective bitstream, wherein the objective bitstream is generated based on the following process: obtaining a coded representation of the objective image, the coded representation comprising values of a group of parameters corresponding to the objective image; determining an objective function associated with a decoder based on the coded representation, the decoder being used to decode a bitstream corresponding to the coded representation; determining a group of adjustments of the group of parameters based on a comparison between a group of change degrees of the objective function with the group of parameters and a threshold degree; adjusting the group of parameters based on the group of adjustments so as to obtain an adjusted coded representation; and obtaining an objective bitstream of the objective image based on the adjusted coded representation.

In some implementations, determining the adjustment of the parameter comprises: in response to determining that a first change degree of the objective function with a first parameter is less than or equal to the threshold degree, determining an adjustment of the first parameter to zero.

In some implementations, determining the adjustment of the parameter comprises: in response to determining that a second change degree of the objective function with a second parameter is larger than the threshold degree, determining an adjustment of the second parameter based on the second change degree so as to cause the adjustment to be proportional to the second change degree.

In some implementations, determining the adjustment based on the second change degree comprises: determining a maximum change degree in the group of change degrees; and determining the adjustment based on a ratio of the second change degree to the maximum change degree so as to cause the adjustment to be proportional to the ratio.

In some implementations, the threshold degree is determined based on a product of a maximum change degree in the group of change degrees and a predetermined coefficient.

In some implementations, the coded representation comprises a first coded representation, the first coded representation being generated by using an encoder to process the objective image.

In some implementations, the coded representation further comprises a second coded representation, the second coded representation being generated based on the first coded representation so as to indicate a distribution characteristic of the first coded representation.

In some implementations, the coded representation comprises multiple partial coded representations corresponding to multiple locations in the objective image, and generating the bitstream comprises: with respect to a given location among the multiple locations, determining a first entropy encoding parameter for indicating a mean value based on the second coded representation, the first entropy encoding parameter being irrelevant to a contextual parameter, the contextual parameter being used to indicate a coded representation of a group of associated locations associated with a given location among the multiple locations; and generating a partial bitstream corresponding to the given location in the objective bitstream at least based on the first entropy encoding parameter.

In some implementations, generating the partial bitstream corresponding to the given location in the objective bitstream at least based on the first entropy encoding parameter comprises: determining a second entropy encoding parameter for indicating a variance based on the second coded representation and the contextual parameter; and generating the partial bitstream corresponding to the given location in the objective bitstream based on the first entropy encoding parameter and the second entropy encoding parameter.

In some implementations, the objective bitstream is encoded with at least one of: first side information, which indicates a quantization parameter for quantizing the coded representation, or second side information, which indicates a post-processing parameter for performing post-processing to a decoded image generated from the objective bitstream.

In some implementations, adjusting the group of parameters based on the group of adjustments comprises: iteratively adjusting the coded representation until a convergence condition associated with the objective function is met.

In a third aspect, the subject matter described herein provides a device. The device comprises: a processing unit; and a memory coupled to the processing unit and comprising instructions stored thereon which, when executed by the processing unit, cause the device to perform acts comprising: obtaining a coded representation of an objective image, the coded representation comprising values of a group of parameters corresponding to the objective image; determining an objective function associated with a decoder based on the coded representation, the decoder being used to decode a bitstream corresponding to the coded representation; determining a group of adjustments of the group of parameters based on a comparison between a group of change degrees of the objective function with the group of parameters and a threshold degree; adjusting the group of parameters based on the group of adjustments so as to obtain an adjusted coded representation; and obtaining an objective bitstream of the objective image based on the adjusted coded representation.

In some implementations, determining the adjustment of the parameter comprises: in response to determining that a first change degree of the objective function with a first parameter is less than or equal to the threshold degree, determining an adjustment of the first parameter to zero.

In some implementations, determining the adjustment of the parameter comprises: in response to determining that a second change degree of the objective function with a second parameter is larger than the threshold degree, determining an adjustment of the second parameter based on the second change degree so as to cause the adjustment to be proportional to the second change degree.

In some implementations, determining the adjustment based on the second change degree comprises: determining a maximum change degree in the group of change degrees; and determining the adjustment based on a ratio of the second change degree to the maximum change degree so as to cause the adjustment to be proportional to the ratio.

In some implementations, the threshold degree is determined based on a product of a maximum change degree in the group of change degrees and a predetermined coefficient.

In some implementations, the coded representation comprises a first coded representation, the first coded representation being generated by using an encoder to process the objective image.

In some implementations, the coded representation further comprises a second coded representation, the second coded representation being generated based on the first coded representation so as to indicate a distribution characteristic of the first coded representation.

In some implementations, the coded representation comprises multiple partial coded representations corresponding to multiple locations in the objective image, and generating the bitstream comprises: with respect to a given location among the multiple locations, determining a first entropy encoding parameter for indicating a mean value based on the second coded representation, the first entropy encoding parameter being irrelevant to a contextual parameter, the contextual parameter being used to indicate a coded representation of a group of associated locations associated with a given location among the multiple locations; and generating a partial bitstream corresponding to the given location in the objective bitstream at least based on the first entropy encoding parameter.

In some implementations, generating the partial bitstream corresponding to the given location in the objective bitstream at least based on the first entropy encoding parameter comprises: determining a second entropy encoding parameter for indicating a variance based on the second coded representation and the contextual parameter; and generating the partial bitstream corresponding to the given location in the objective bitstream based on the first entropy encoding parameter and the second entropy encoding parameter.

In some implementations, the objective bitstream is encoded with at least one of: first side information, which indicates a quantization parameter for quantizing the coded representation, or second side information, which indicates a post-processing parameter for performing post-processing to a decoded image generated from the objective bitstream.

In some implementations, adjusting the group of parameters based on the group of adjustments comprises: iteratively adjusting the coded representation until a convergence condition associated with the objective function is met.

In a fourth aspect, the subject matter described herein provides a device. The device comprises: a processing unit; and a memory coupled to the processing unit and comprising instructions stored thereon which, when executed by the processing unit, cause the device to perform acts comprising: receiving an objective bitstream corresponding to an objective image; and decoding an image from the objective bitstream, wherein the objective bitstream is generated based on the following process: obtaining a coded representation of the objective image, the coded representation comprising values of a group of parameters corresponding to the objective image; determining an objective function associated with a decoder based on the coded representation, the decoder being used to decode a bitstream corresponding to the coded representation; determining a group of adjustments of the group of parameters based on a comparison between a group of change degrees of the objective function with the group of parameters and a threshold degree; adjusting the group of parameters based on the group of adjustments so as to obtain an adjusted coded representation; and obtaining an objective bitstream of the objective image based on the adjusted coded representation.

In some implementations, determining the adjustment of the parameter comprises: in response to determining that a first change degree of the objective function with a first parameter is less than or equal to the threshold degree, determining an adjustment of the first parameter to zero.

In some implementations, determining the adjustment of the parameter comprises: in response to determining that a second change degree of the objective function with a second parameter is larger than the threshold degree, determining an adjustment of the second parameter based on the second change degree so as to cause the adjustment to be proportional to the second change degree.

In some implementations, determining the adjustment based on the second change degree comprises: determining a maximum change degree in the group of change degrees; and determining the adjustment based on a ratio of the second change degree to the maximum change degree so as to cause the adjustment to be proportional to the ratio.

In some implementations, the threshold degree is determined based on a product of a maximum change degree in the group of change degrees and a predetermined coefficient.

In some implementations, the coded representation comprises a first coded representation, the first coded representation being generated by using an encoder to process the objective image.

In some implementations, the coded representation further comprises a second coded representation, the second coded representation being generated based on the first coded representation so as to indicate a distribution characteristic of the first coded representation.

In some implementations, the coded representation comprises multiple partial coded representations corresponding to multiple locations in the objective image, and generating the bitstream comprises: with respect to a given location among the multiple locations, determining a first entropy encoding parameter for indicating a mean value based on the second coded representation, the first entropy encoding parameter being irrelevant to a contextual parameter, the contextual parameter being used to indicate a coded representation of a group of associated locations associated with a given location among the multiple locations; and generating a partial bitstream corresponding to the given location in the objective bitstream at least based on the first entropy encoding parameter.

In some implementations, generating the partial bitstream corresponding to the given location in the objective bitstream at least based on the first entropy encoding parameter comprises: determining a second entropy encoding parameter for indicating a variance based on the second coded representation and the contextual parameter; and generating the partial bitstream corresponding to the given location in the objective bitstream based on the first entropy encoding parameter and the second entropy encoding parameter.

In some implementations, the objective bitstream is encoded with at least one of: first side information, which indicates a quantization parameter for quantizing the coded representation, or second side information, which indicates a post-processing parameter for performing post-processing to a decoded image generated from the objective bitstream.

In some implementations, adjusting the group of parameters based on the group of adjustments comprises: iteratively adjusting the coded representation until a convergence condition associated with the objective function is met.

In a fifth aspect, the subject matter described herein provides a computer program product being tangibly stored in a non-transitory computer storage medium and comprising machine-executable instructions which, when executed by a device, causing the device to perform acts comprising: obtaining a coded representation of an objective image, the coded representation comprising values of a group of parameters corresponding to the objective image; determining an objective function associated with a decoder based on the coded representation, the decoder being used to decode a bitstream corresponding to the coded representation; determining a group of adjustments of the group of parameters based on a comparison between a group of change degrees of the objective function with the group of parameters and a threshold degree; adjusting the group of parameters based on the group of adjustments so as to obtain an adjusted coded representation; and obtaining an objective bitstream of the objective image based on the adjusted coded representation.

In some implementations, determining the adjustment of the parameter comprises: in response to determining that a first change degree of the objective function with a first parameter is less than or equal to the threshold degree, determining an adjustment of the first parameter to zero.

In some implementations, determining the adjustment of the parameter comprises: in response to determining that a second change degree of the objective function with a second parameter is larger than the threshold degree, determining an adjustment of the second parameter based on the second change degree so as to cause the adjustment to be proportional to the second change degree.

In some implementations, determining the adjustment based on the second change degree comprises: determining a maximum change degree in the group of change degrees; and determining the adjustment based on a ratio of the second change degree to the maximum change degree so as to cause the adjustment to be proportional to the ratio.

In some implementations, the threshold degree is determined based on a product of a maximum change degree in the group of change degrees and a predetermined coefficient.

In some implementations, the coded representation comprises a first coded representation, the first coded representation being generated by using an encoder to process the objective image.

In some implementations, the coded representation further comprises a second coded representation, the second coded representation being generated based on the first coded representation so as to indicate a distribution characteristic of the first coded representation.

In some implementations, the coded representation comprises multiple partial coded representations corresponding to multiple locations in the objective image, and generating the bitstream comprises: with respect to a given location among the multiple locations, determining a first entropy encoding parameter for indicating a mean value based on the second coded representation, the first entropy encoding parameter being irrelevant to a contextual parameter, the contextual parameter being used to indicate a coded representation of a group of associated locations associated with a given location among the multiple locations; and generating a partial bitstream corresponding to the given location in the objective bitstream at least based on the first entropy encoding parameter.

In some implementations, generating the partial bitstream corresponding to the given location in the objective bitstream at least based on the first entropy encoding parameter comprises: determining a second entropy encoding parameter for indicating a variance based on the second coded representation and the contextual parameter; and generating the partial bitstream corresponding to the given location in the objective bitstream based on the first entropy encoding parameter and the second entropy encoding parameter.

In some implementations, the objective bitstream is encoded with at least one of: first side information, which indicates a quantization parameter for quantizing the coded representation, or second side information, which indicates a post-processing parameter for performing post-processing to a decoded image generated from the objective bitstream.

In some implementations, adjusting the group of parameters based on the group of adjustments comprises: iteratively adjusting the coded representation until a convergence condition associated with the objective function is met.

In a sixth aspect, the subject matter described herein provides a computer program product including machine-executable instructions which, when executed by a device, cause the device to perform acts comprising: receiving an objective bitstream corresponding to an objective image; and decoding an image from the objective bitstream, wherein the objective bitstream is generated based on the following process: obtaining a coded representation of the objective image, the coded representation comprising values of a group of parameters corresponding to the objective image; determining an objective function associated with a decoder based on the coded representation, the decoder being used to decode a bitstream corresponding to the coded representation; determining a group of adjustments of the group of parameters based on a comparison between a group of change degrees of the objective function with the group of parameters and a threshold degree; adjusting the group of parameters based on the group of adjustments so as to obtain an adjusted coded representation; and obtaining an objective bitstream of the objective image based on the adjusted coded representation.

In some implementations, determining the adjustment of the parameter comprises: in response to determining that a first change degree of the objective function with a first parameter is less than or equal to the threshold degree, determining an adjustment of the first parameter to zero.

In some implementations, determining the adjustment of the parameter comprises: in response to determining that a second change degree of the objective function with a second parameter is larger than the threshold degree, determining an adjustment of the second parameter based on the second change degree so as to cause the adjustment to be proportional to the second change degree.

In some implementations, determining the adjustment based on the second change degree comprises: determining a maximum change degree in the group of change degrees; and determining the adjustment based on a ratio of the second change degree to the maximum change degree so as to cause the adjustment to be proportional to the ratio.

In some implementations, the threshold degree is determined based on a product of a maximum change degree in the group of change degrees and a predetermined coefficient.

In some implementations, the coded representation comprises a first coded representation, the first coded representation being generated by using an encoder to process the objective image.

In some implementations, the coded representation further comprises a second coded representation, the second coded representation being generated based on the first coded representation so as to indicate a distribution characteristic of the first coded representation.

In some implementations, the coded representation comprises multiple partial coded representations corresponding to multiple locations in the objective image, and generating the bitstream comprises: with respect to a given location among the multiple locations, determining a first entropy encoding parameter for indicating a mean value based on the second coded representation, the first entropy encoding parameter being irrelevant to a contextual parameter, the contextual parameter being used to indicate a coded representation of a group of associated locations associated with a given location among the multiple locations; and generating a partial bitstream corresponding to the given location in the objective bitstream at least based on the first entropy encoding parameter.

In some implementations, generating the partial bitstream corresponding to the given location in the objective bitstream at least based on the first entropy encoding parameter comprises: determining a second entropy encoding parameter for indicating a variance based on the second coded representation and the contextual parameter; and generating the partial bitstream corresponding to the given location in the objective bitstream based on the first entropy encoding parameter and the second entropy encoding parameter.

In some implementations, the objective bitstream is encoded with at least one of: first side information, which indicates a quantization parameter for quantizing the coded representation, or second side information, which indicates a post-processing parameter for performing post-processing to a decoded image generated from the objective bitstream.

In some implementations, adjusting the group of parameters based on the group of adjustments comprises: iteratively adjusting the coded representation until a convergence condition associated with the objective function is met.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or a server.

In the context of this subject matter described herein, a machine-readable medium may be any tangible medium that may contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the particular order shown or in a sequential order, or all operations shown are required to be executed to achieve the expected results. In certain circumstances, multitasking and parallel processing may be advantageous. Likewise, while several specific implementation details are contained in the above discussions, these should not be construed as limitations on the scope of the subject matter described herein. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1.-14. (canceled)

15. A method for image encoding, comprising:
obtaining a coded representation of an objective image, the coded representation comprising values of a group of parameters corresponding to the objective image;
determining an objective function associated with a decoder based on the coded representation, the decoder being used to decode a bitstream corresponding to the coded representation;
determining a group of adjustments of the group of parameters based on a comparison between a group of change degrees of the objective function with the group of parameters and a threshold degree;
adjusting the group of parameters based on the group of adjustments so as to obtain an adjusted coded representation; and
obtaining an objective bitstream of the objective image based on the adjusted coded representation.

16. The method of claim 15, wherein the determining the group of adjustments comprises:
in response to determining that a first change degree of the objective function with a first parameter, among the group of parameters, is less than or equal to the threshold degree, determining an adjustment of the first parameter to be zero.

17. The method of claim 15, wherein the determining the group of adjustments comprises:
in response to determining that a second change degree of the objective function with a second parameter, among the group of parameters, is larger than the threshold degree, determining an adjustment of the second parameter based on the second change degree so as to cause the adjustment to be proportional to the second change degree.

18. The method of claim 17, wherein the determining the adjustment based on the second change degree comprises:
determining a maximum change degree in the group of change degrees; and
determining the adjustment based on a ratio of the second change degree to the maximum change degree so as to cause the adjustment to be proportional to the ratio.

19. The method of claim 15, wherein the threshold degree is determined based on a product of a maximum change degree in the group of change degrees and a predetermined coefficient.

20. The method of claim 15, wherein the coded representation comprises a first coded representation, the first coded representation being generated by using an encoder to process the objective image.

21. The method of claim 20, wherein the coded representation further comprises a second coded representation, the second coded representation being generated based on the first coded representation so as to indicate a distribution characteristic of the first coded representation.

22. The method of claim 21, wherein the coded representation comprises multiple partial coded representations corresponding to multiple locations in the objective image, and wherein generating the bitstream comprises, with respect to a given location among the multiple locations:
determining a first entropy encoding parameter for indicating a mean value based on the second coded representation, the first entropy encoding parameter being irrelevant to a contextual parameter, the contextual parameter being used to indicate a coded representation of a group of associated locations associated with a given location among the multiple locations; and
generating a partial bitstream corresponding to the given location in the objective bitstream based at least in part on the first entropy encoding parameter.

23. The method of claim 22, wherein generating the partial bitstream corresponding to the given location in the objective bitstream based at least in part on the first entropy encoding parameter comprises:
determining a second entropy encoding parameter for indicating a variance based on the second coded representation and the contextual parameter; and
generating the partial bitstream corresponding to the given location in the objective bitstream based on the first entropy encoding parameter and the second entropy encoding parameter.

24. The method of claim 15, wherein the objective bitstream is encoded with at least one of:
first side information, which indicates a quantization parameter for quantizing the coded representation; and
second side information, which indicates a post-processing parameter for performing post-processing on a decoded image generated from the objective bitstream.

25. The method of claim 15, wherein the adjusting the group of parameters based on the group of adjustments comprises:
iteratively adjusting the coded representation until a convergence condition associated with the objective function is met.

26. A method for image decoding, the method comprising:
receiving an objective bitstream corresponding to an objective image, wherein the objective bitstream has been generated based on operations comprising:
obtaining a coded representation of the objective image, the coded representation comprising values of a group of parameters corresponding to the objective image;
determining an objective function associated with a decoder based on the coded representation, the decoder being used to decode a bitstream corresponding to the coded representation;
determining a group of adjustments of the group of parameters based on a comparison between a group of change degrees of the objective function with the group of parameters and a threshold degree;
adjusting the group of parameters based on the group of adjustments so as to obtain an adjusted coded representation; and
obtaining an objective bitstream of the objective image based on the adjusted coded representation; and
decoding an image from the objective bitstream.

27. A device, comprising:
a processing unit; and
a memory coupled to the processing unit and comprising instructions stored thereon which, when executed by the processing unit, cause the device to perform acts comprising:
obtaining a coded representation of an objective image, the coded representation comprising values of a group of parameters corresponding to the objective image;
determining an objective function associated with a decoder based on the coded representation, the decoder being used to decode a bitstream corresponding to the coded representation;
determining a group of adjustments of the group of parameters based on a comparison between a group of change degrees of the objective function with the group of parameters and a threshold degree;
adjusting the group of parameters based on the group of adjustments so as to obtain an adjusted coded representation; and
obtaining an objective bitstream of the objective image based on the adjusted coded representation.

28. The device of claim 27, wherein the determining the group of adjustments comprises:
in response to determining that a first change degree of the objective function with a first parameter, among the group of parameters, is less than or equal to the threshold degree, determining an adjustment of the first parameter to be zero.

29. The device of claim 27, wherein the determining the group of adjustments comprises:
in response to determining that a second change degree of the objective function with a second parameter, among the group of parameters, is larger than the threshold degree, determining an adjustment of the second parameter based on the second change degree so as to cause the adjustment to be proportional to the second change degree.

30. The device of claim 29, wherein the determining the adjustment based on the second change degree comprises:
determining a maximum change degree in the group of change degrees; and
determining the adjustment based on a ratio of the second change degree to the maximum change degree so as to cause the adjustment to be proportional to the ratio.

31. The device of claim 27, wherein the threshold degree is determined based on a product of a maximum change degree in the group of change degrees and a predetermined coefficient.

32. The device of claim 27, wherein the coded representation comprises a first coded representation, the first coded representation being generated by using an encoder to process the objective image.

33. The device of claim 32, wherein the coded representation further comprises a second coded representation, the second coded representation being generated based on the first coded representation so as to indicate a distribution characteristic of the first coded representation.

34. The device of claim 27, wherein the objective bitstream is encoded with at least one of:
first side information, which indicates a quantization parameter for quantizing the coded representation; and
second side information, which indicates a post-processing parameter for performing post-processing on a decoded image generated from the objective bitstream.
